(19) United States
(12) Patent Application Publication
(10) Pub. No.: US 2022/0094237 A1
(43) Pub. Date: Mar. 24, 2022

(54) ELECTRIC MOTOR WITH HEAT DISSIPATION FOR THE MOTOR SHAFT BEARING

(71) Applicant: ebm-papst St. Georgen GmbH & Co. KG, St. Georgen (DE)

(72) Inventors: Michael KISCH, St. Georgen (DE); Wilhelm WEISSER, Koenigsfeld/Buchenberg (DE); Jochen SCHEFFCZYK, Villingen-Schwenningen (DE); Hassan GHODSI-KHAMENEH, Offenburg (DE); Daniel HAUER, Ortenberg (DE); Marcus HELLMANN, Unterkirnach (DE)

(21) Appl. No.: 17/423,456

(22) PCT Filed: Oct. 29, 2019
(86) PCT No.: PCT/EP2019/079556

§ 371 Date: Jul. 15, 2021

(30) Foreign Application Priority Data
Jan. 30, 2019 (DE) 10 2019 102 365.3

(51) Int. Cl. H02K 5/18; H02K 9/22; H02K 5/15; H02K 5/02; H02K 5/173; H02K 5/128

(52) U.S. Cl. CPC H02K 5/18; H02K 9/22; H02K 5/128; H02K 5/02; H02K 5/173; H02K 5/15

(57) ABSTRACT

An electric motor has a motor casing (2) which has a shaft portion for accommodating a motor shaft (4), and a motor portion for accommodating motor electronics (5) and motor windings (6). The shaft portion and the motor portion are separated from each other in a sealed manner by a can (7) in the motor casing (2). The can (7) has a metal ball bearing housing (8) in which a ball bearing (9) for mounting the motor shaft (4) is fastened, and wherein the ball bearing housing (8), indirectly via the can (7), adjoins, with an intermediate gap, a casing cover (3) that forms part of the motor casing (2). The casing cover (3) acts as a heat sink, and heat generated by the ball bearing (9) during operation is dissipated onto the casing cover and into the outer environment via the ball bearing housing (8) and the can (7).

### FIELD

The disclosure relates to an electric motor in a compact design with heat dissipation for the motor shaft bearing.

### BACKGROUND

In the case of electric motors which produce a high rotational speed of the motor shaft, the power dissipation of the ball bearings supporting the motor shaft increases significantly due to strong heat generation. Especially with compact implementations of the electric motor, in which the ball bearing is arranged directly adjacent to many other components, the generated heat cannot be dissipated sufficiently.

### SUMMARY

The technical solution provided by example embodiments of the disclosure is an improved heat dissipation for the ball bearing supporting the motor shaft in an electric motor.

The above-referenced technical problem is addressed by the technical solution provided by the combination of features according to claim 1, for example.

According to an example embodiment of the disclosure, an electric motor with a motor casing is proposed, which motor casing has a shaft portion for accommodating a motor shaft and a motor portion for accommodating a motor electronics and motor windings. The shaft portion and the motor portion are separated from each other in a sealed manner by a can arranged in the motor casing, wherein a metal ball bearing housing is arranged in the can, in which ball bearing housing a ball bearing is fastened for supporting the motor shaft. The ball bearing housing, via the can, indirectly adjoins the casing cover, which forms a part of the motor casing, with an intermediary gap, such that the housing cover acts as a heat sink and heat generated by the ball bearing during operation is dissipated via the ball bearing housing and via the can to the casing cover and the outer environment.

The can is used to separate the shaft portion and the motor portion, and to prevent a gas exchange between the crankcase and the electronics or the motor windings.

However, having the ball bearing housing arranged in the can results in a design in which the ball bearing is arranged in the center of the design and packed tight between other components, and is thus unable to dissipate much of its heat generated during operation to the outside. According to the example embodiment, the heat dissipation is conducted by means of a connection of the can and ball bearing housing to the casing cover of the motor casing via the ball bearing accommodated in the ball bearing housing.

The gap between the casing cover 3 and the can 7 has a gap dimension of zero in a first embodiment variant. The casing cover thus directly abuts the can. The ball bearing housing, which in turn is located in the can, is thus also in direct connection with the casing cover, such that the heat is dissipated from the ball bearing housing via the can to the casing cover and on to the outside environment.

In an alternative embodiment, the gap between the casing cover and the can has a small gap dimension, which measures up to 1/20 of the maximum outer diameter of the ball bearing. The small gap hardly affects the heat dissipation from the ball bearing housing to the casing cover, but allows for an arrangement of the components relative to each other, without contact.

In an embodiment variant of the electric motor, it is provided that the can is formed integrally with the motor casing about a rotational axis of the motor shaft. In particular, the motor casing forms a circumferential outer wall, with which an axial wall is connected on an axial side, into which axial wall the can is sunk. The can is preferably formed as a hollow cylinder with portions of different diameters, wherein the ball bearing housing is arranged in the portion axially protruding the farthest into the motor casing.

In this case, an embodiment is advantageous, in which the can and the ball bearing housing are designed in identical shapes in the portion of the can in which the ball bearing housing is arranged. In other words, the ball bearing housing and the can define the same outer contours.

Of further advantage is realized by an embodiment of the electric motor, in which a thermal paste or a thermal adhesive is provided between the can and the casing cover. The thermal paste preferably forms an intermediate layer and allows for a thermal connection of the casing cover to the can without said components making contact with each other. This means that vibrations of the individual components remain decoupled from each other. The use of a thermal adhesive makes it possible to glue the casing cover to the can, in addition to providing the advantageous effect of the thermal paste.

In one exemplary embodiment, the casing cover is attached to the motor casing in a detachable manner, and is mounted on an axial side of the remaining motor casing. The casing cover thus forms the portion of the motor casing, which is indirectly connected with the ball bearing housing via the can, and thus also with the ball bearing. Insofar as the can is formed integrally with the motor casing, the assembly of the components of the electric motor can be carried out via the side axially opposite to the can, on which side the casing cover is positioned in a detachable manner. At the same time, the solution with a casing cover as a heat sink offers a large surface for heat dissipation to the outer environment.

The performance of the heat dissipation is further improved in a variant of the electric motor, in which the casing cover has a cooling element axially protruding in the direction of the outer environment, which cooling element locally enlarges the cooling surface of the casing cover. Preferably, a plurality of cooling fins distributed across the casing cover are formed on the casing cover as a cooling element. The cooling fins can in particular be formed integrally with the casing cover or alternatively be attached to it in an integral manner. It is also advantageous if multiple of the cooling fins protrude beyond the ball bearing housing as seen in axial projection, such that the heat locally generated on the ball bearing housing is directed to the outer environment in a particular quick and effective manner.

The heat dissipation is also favored by the fact that the casing cover is formed from metal or heat-conducting plastic.

In an advantageous example embodiment, the ball bearing housing forms a ball bearing seat into which the ball bearing is pressed.

Furthermore, a variant of the electric motor is characterized in that the ball bearing housing has a clearance between the ball bearing and the portion of the motor casing connected to the outer environment. The ball bearing can thus immediately release heat to the air into the open space and is not in direct contact with the axial surface of the ball bearing housing, which abuts the can and the heat sink.

Furthermore, in a refinement of the electric motor, it is provided that the can extends axially through the motor casing to the casing cover. The can thus defines a significant part of the centrally interior motor casing about the rotational axis, as seen in the axial direction, i.e., along the rotational axis of the motor shaft. Preferably, the can extends in the axial direction across 60-95%, further preferably across 70-95%, even further preferably across 80-90% of the total axial extension of the motor casing.

In accordance with a further advantageous example embodiment, the motor casing and the can are formed from plastic and the metal ball bearing housing is overmolded with the plastic directly during the injection molding process.

It is beneficial for a compact design of the electric motor that the windings surround the can in the circumferential direction. At the same time, it is advantageous that the windings are arranged axially spaced apart from the ball bearing. Thus, the heat generation of the motor windings remains separate from that of the ball bearing.

A further advantageous example embodiment for a compact design of the electric motor is that the motor electronics is arranged on a printed circuit board, which has a central opening, and that a cooling element protruding from the casing cover extends through the central opening. However, it is beneficial that the can extends through the central opening.

### BRIEF DESCRIPTION OF THE DRAWINGS

Other advantageous refinements of the example embodiments of the disclosure are characterized in the dependent claims and/or are described in more detail through the drawings in conjunction with the description of the example embodiments of the disclosure. In the drawings:

FIG. 1 is a lateral sectional view through an electric motor of an exemplary embodiment; and

FIG. 2 is a detail view of FIG. 1.

### DETAILED DESCRIPTION OF EXAMPLE EMBODIMENTS

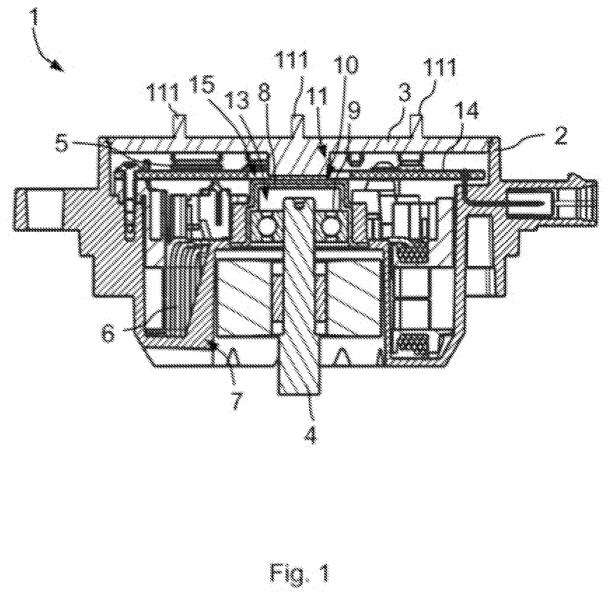

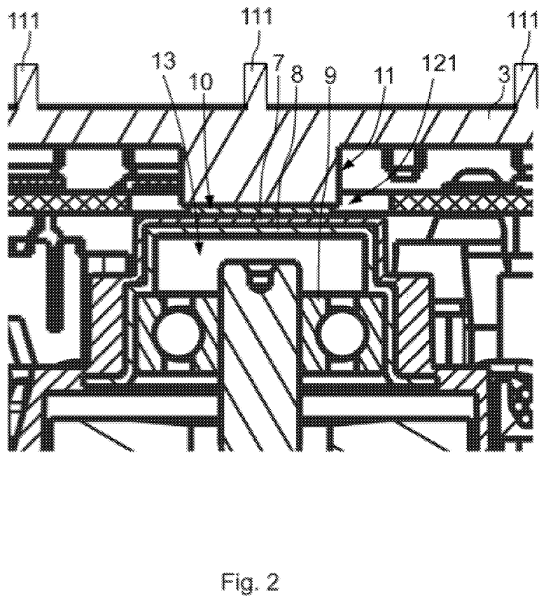

FIGS. 1 and 2 show an electric motor 1 configured according to an example embodiment of the disclosure in a lateral sectional view or, respectively, a detail view.

The electric motor 1 comprises the single-piece motor casing 2 with the casing cover 3, which can be fastened axially on the motor casing 2 and which forms a part of the motor casing in the fastened state. On the side axially opposite to the casing cover 3, the motor casing 2 integrally forms the can 7 axially extending into the interior of the motor casing 2. The motor portion, in which the motor windings 6 and the motor electronics 5 mounted on the printed circuit board 14 are accommodated, is positioned between the inner wall of the motor casing 2 and the outer sheath of the can 7. The shaft portion, in which the motor shaft 4 extends along its rotational axis, is positioned within the can 7 in a manner such that it is separated from the can 7 in a sealing manner. The can 7 extends in the axial direction essentially through the entire motor casing 2 up to the casing cover 3.

The ball bearing housing 8, which is formed from a thermally conductive material, in particular from metal, is arranged in the deepest portion of the can 7, as seen in the axial direction. The motor casing 2 with the can 7 is molded from plastic around the ball bearing housing 8 using an injection molding process, such that the can 7 and the ball bearing housing 8 have the same shape or the same inner and outer contour and directly abut each other. The ball bearing housing 8 defines the bearing seat for the pressed-in ball bearing 9, in which the motor shaft 4 is supported. The clearance 13 is formed between the ball bearing 9 and the axial inner wall surface of the can 7, into which clearance 13 the motor shaft 4 extends with its free end.

A cooling element 11 in the form of a cylinder formed from solid material is formed about the rotational axis and integrally with the casing cover 3, which cooling element 11 axially protrudes in the direction of the ball bearing housing 8. The gap 121, which has a gap dimension of no more than 1/20 of the outer diameter of the ball bearing, is located axially between the cooling element 11 and the axial outer wall surface of the can 7. A layer of the thermal paste 10 is provided in the gap 121 in the embodiment shown here, which thermal paste 10 can also be replaced by thermal adhesive.

The heat dissipation of the heat generated by the ball bearing 9 during operation is carried out starting from the ball bearing 9 to the ball bearing housing 8, further to the can 7 and on in the axial direction to the cooling element 11 of the casing cover 3 of the motor casing 2 via the thermal paste 10. From the casing cover 3, the heat is further dissipated to the outer environment. The motor casing and in particular its casing cover 3 therefore act as a heat sink. In an alternative version (not shown), the thermal paste 10 is dispensed with and the cooling element 11 directly contacts the can 7. The gap 121 then has a gap dimension of zero.

The can 7 is a hollow cylinder and is divided into three axial portions with different inner diameters. The clearance 13 is located in the region of the smallest diameter, the bearing seat with the ball bearing 9 in the middle region, and the motor windings 6 are arranged radially around the can 7 in the region with the largest inner diameter. The ball bearing 9 thus does not overlap with the motor windings 5, as seen in the axial direction.

The printed circuit board 14 defines the central opening 15 about the rotational axis of the motor shaft 4, through which central opening 15 extends the cooling element 11 axially protruding from the casing cover 3 to the can 7. In an alternative variant, which is not shown here, but which also is covered by the disclosure, the region of the smallest diameter of the can 7, instead of the cooling element 11, extends through the opening 15 or at least extends into the opening 15, such that contact is made between the can 7 and the cooling element 11 at the level of the printed circuit board 14 or axially above the printed circuit board 14. In a further alternative embodiment, it is provided to design the casing cover 3 without a cooling element 11 and to bring the can 7 into contact with the axial inner wall of the housing cover 3 directly or via the thermal paste 10 or the thermal adhesive.

The housing cover 3 forms a plurality of cooling fins 111 distributed across its surface facing the outer environment, which cooling fins 111 extend partially centrally, i.e., across the ball bearing housing 8 as seen in axial projection. This means that the heat generated in the area of the ball bearing housing 8 is directed to the outer environment more quickly.

1. An electric motor having a motor casing (2) which has a shaft portion for accommodating a motor shaft (4), and a motor portion for accommodating motor electronics (5) and motor windings (6), wherein the shaft portion and the motor portion are separated from each other in a sealed manner by a can (7) that is arranged in the motor casing (2), wherein the can (7) is equipped with a metal ball bearing housing (8) in which a ball bearing (9) for mounting the motor shaft (4) is fastened, and wherein the ball bearing housing (8), indirectly via the can (7), adjoins, with an intermediate gap (121), a casing cover (3) that forms part of the motor casing (2), such that the casing cover (3) acts as a heat sink, and heat generated by the ball bearing (9) during operation is dissipated onto the casing cover and into the outer environment via the ball bearing housing (8) and the can (7).

2. The electric motor according to claim 1, characterized in that the gap (121) between the casing cover (3) and the can (7) has a gap dimension of zero, and the casing cover (3) thus directly abuts the can (7).

3. The electric motor according to claim 1, characterized in that the gap (121) between the casing cover (3) and the can (7) has a gap dimension, which measures no greater than 1/20 of the maximum outer diameter of the ball bearing (9).

4. The electric motor according to claim 1, characterized in that the can (7) is formed integrally with the motor casing (2) about a rotational axis of the motor shaft (4).

5. The electric motor according to claim 1, characterized in that the can (7) and the ball bearing housing (8) are designed to be of identical shapes in the portion of the can (7), in which the ball bearing housing (8) is arranged.

6. The electric motor according to claim 1, characterized in that a thermal paste (10) or a thermal adhesive is provided between the can (7) and the casing cover (3).

7. The electric motor according to claim 1, characterized in that the casing cover (3) can be detachably mounted on an axial side of the remaining motor casing (2) and forms a part of the motor casing.

8. The electric motor according to claim 1, characterized in that the casing cover (3) has at least one cooling element axially protruding in the direction of the outer environment, which locally enlarges a cooling surface of the casing cover (3) in contact with the outer environment.

9. The electric motor according to claim 1, characterized in that the at least one cooling element is designed as a plurality of cooling fins (111) distributed across the casing cover (3).

10. The electric motor according to claim 1, characterized in that multiple of the cooling fins (111) protrude beyond the ball bearing housing (8) as seen in axial projection.

11. The electric motor according to claim 1, characterized in that the casing cover (3) is formed from metal or heat-conducting plastic.

12. The electric motor according to claim 1, characterized in that the ball bearing housing (8) has a clearance (13) between the ball bearing (9) and the portion of the motor casing (2) connected to the outer environment.

13. The electric motor according to claim 1, characterized in that the can (7) and the ball bearing housing (8) extend axially through the motor casing (2) to the casing cover (3).

14. The electric motor according to claim 1, characterized in that the motor windings (6) surround the can (7) in the circumferential direction and are arranged axially spaced apart from the ball bearing (9).

15. The electric motor according to claim 1, characterized in that the motor electronics (5) is arranged on a printed circuit board (14) which has a central opening (15), and that the can (7) extends through the central opening (15).
